(19) United States
(12) Patent Application Publication
(10) Pub. No.: US 2010/0154936 A1
(43) Pub. Date: Jun. 24, 2010

(54) PROTECTIVE COATING AND PROCESS FOR PRODUCING THE SAME

(75) Inventor: David J. Urevich, Wentzville, MO (US)

Correspondence Address: Polster, Lieder, Woodruff & Lucchesi, L.C., 12412 Powerscourt Dr. Suite 200, St. Louis, MO, 63131-3615, US

(73) Assignee: ARCMELT COMPANY, LC, Bridgeton, MO (US)

(21) Appl. No.: 12/593,868

(22) PCT Filed: Mar. 27, 2008
(86) PCT No.: PCT/US08/58372

§ 371 Date: Feb. 18, 2010

Related U.S. Application Data
(60) Provisional application No. 60/921,130, filed on Mar. 30, 2007.

(51) Int. Cl. C23C 8/20; B32B 5/18

(52) U.S. Cl. 148/210; 428/613

(57) ABSTRACT

A coating (4) that is metallurgically bonded to a metal substrate (2) to protect the substrate includes carbide precipitates (10) of irregular and angular shape and a matrix (12) in which the precipitates are embedded. In a flame spraying procedure that utilizes a wire having a metal case and a core containing metal carbides, metals are deposited on the substrate as a basic coating. When that coating is subjected to a carbon rich environment, the carbon unites with the more reactive metals in the basic coating to form carbide precipitates of those metals, leaving the remaining metals to form the matrix. The carbide precipitates possess irregular and angular configurations and remain firmly embedded in the matrix, even though some of the matrix may disappear through the effects of erosion, corrosion, abrasion or wear.

### CROSS-REFERENCE TO RELATED APPLICATION

This application derives and claims priority from U.S. provisional application 60/921,130 filed 30 Mar. 2007, which application is incorporated herein by reference.

### TECHNICAL FIELD

This invention relates in general to protective coatings and, more particularly, to a protective coating applied to a metal substrate, with the coating containing precipitated carbides which are encased in a carbon matrix, and to a process for applying the coating over the substrate.

### BACKGROUND ART

Steels possess considerable strength and are readily available at modest cost. This makes steels well suited for a wide variety of machine components and piping—at least from a structural standpoint. But some machine components operate in environments that attack steel through corrosion and erosion. Other components encounter abrasion and wear. These machine components require protective coatings that can withstand the environments and conditions to which they are subjected. The same holds true for piping that carries corrosive or erosive substances. Protective coatings exist that, when applied to a steel substrate, will isolate the substrate from corrosive or erosive substances and will protect the substrate against abrasion and wear and thus preserve the structural integrity of the substrate.

One coating that has met with some success relies on carbide nodules embedded in a matrix that to a measure resists attack from the substance to which it is exposed—that is to say, from a substance that would damage the underlying steel substrate through corrosion, erosion, abrasion and the like. The process for applying the coating begins with mixing small nodules of a carbide with selected powders and organic binders. The powders may be those of metals, such as nickel or chromium, that will resist most corrosive substances better than steel. The nodules are typically tungsten carbide, which is extremely hard and thus capable of resisting abrasion and wear. The mixing produces a paste, and that paste is rolled or extruded onto a mesh to enable the paste to be handled in sheet form. Indeed, the sheet is applied to the steel shape that is to be protected simply by placing it against the shape and temporarily securing it with a low temperature adhesive. Next the shape with the sheet adhered to it undergoes heating in an inert atmosphere to elevate its temperature to about 2012° F. (about 1100° C.). The heating brazes the sheet and the components carried by it to the steel shape. The coating so formed contains the carbide nodules embedded in a matrix, with the constituency of the matrix depending on the materials in the initial mixture.

While the coating may protect the underlying steel from corrosive environments—at least initially—its nodules are not very effective in resisting erosion; and erosion may eventually remove enough of the coating to expose the steel. In this regard, the matrix is soft in comparison to the carbide nodules and erodes between the carbide nodules (as seen in FIG. 1), which themselves are generally spherical and devoid of angles which might otherwise interlock with the matrix (FIG. 1). After time the carbide nodules at the surface simply fall out of the matrix, exposing more carbide nodules that are deeper in the matrix. With continued erosion they too fall out, and eventually the steel of the substrate is exposed.

Apart from that, the sheet that carries the carbide particles and the matrix-forming substances does not conform to sharp angles, and thus the process is suited for use only on flat surfaces or surfaces having gentle contours.

### BRIEF DESCRIPTION OF THE DRAWINGS

FIG. 1 is a plan view of a conventional protective coating that contains carbide particles, with the coating having suffered erosion that exposes the carbide particles;

FIG. 2 is a top perspective view of a metallic substrate having a protective coating formed in accordance with the present invention.

FIG. 3 is a photomicrograph of a section after a first step of the process;

FIG. 4 is a photomicrograph of a the coating, after carburization of the layer applied to the substrate in FIG. 3; and

FIG. 5 is a photomicrograph of the coating enlarged sufficiently to show the enlarged and irregularly shaped carbide precipitates in the coating.

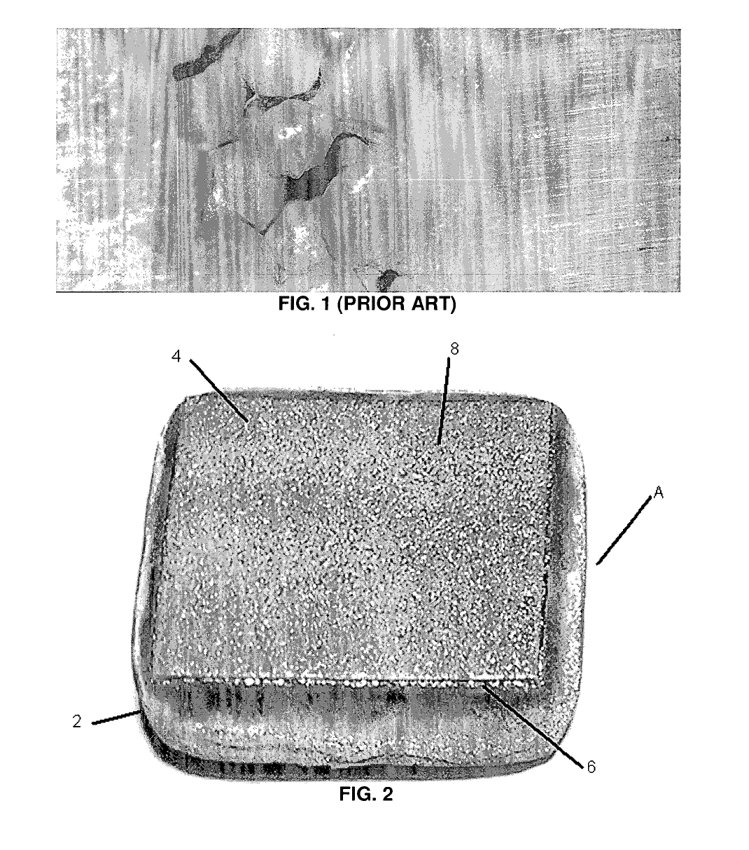

### BEST MODE FOR CARRYING OUT THE INVENTION

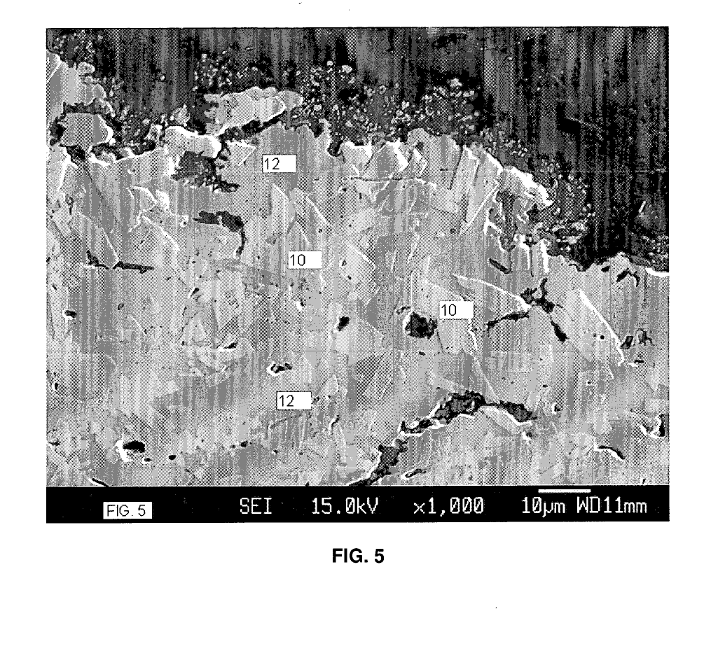

A metallic structure A (FIGS. 2-5), which may be a machine component, the wall of a pipe or tube, etc., includes a steel or other metal substrate 2 and a coating 4 which is bonded to the substrate 2 at an interface 6. The coating 4 isolates the substrate 2 from an environment or conditions that might otherwise corrode, erode, wear down, or abrade the substrate 2. The coating 4 has an exterior or wear surface 8 which is exposed to the environment and conditions that would otherwise damage the substrate 2. To resist attack, the coating 4 contains enlarged particles in the form of carbide precipitates 10 and a matrix 12 in which the carbide precipitates are embedded (FIG. 5), with the matrix being metallurgically bonded to the substrate.

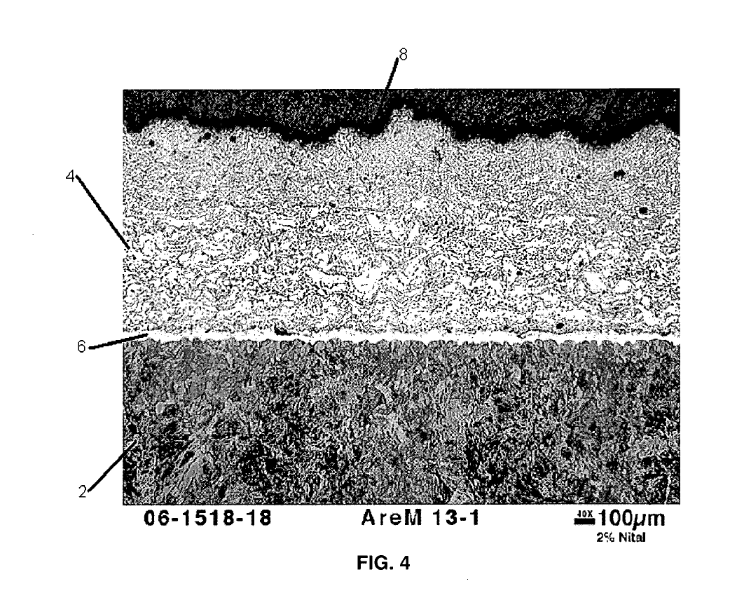

The coating 4 should range between about 0.010 and about 0.060 inches (between about 0.25 mm and about 1.5 mm) in thickness and should preferably be about 0.040 inches (about 1 mm) thick. The matrix 12 should comprise a metal or a combination of metals, such as nickel, chromium and cobalt. The carbide precipitates 10, in contrast to the carbide particles of traditional coatings, are irregular in shape, possessing multiple angular projections and angular recesses, as can be seen in FIG. 5. The matrix 12 envelopes the projections and occupies the recesses of the carbide precipitates, so that the precipitates 10 are firmly captured in the matrix 12 (FIG. 5). The carbide precipitates 10 are present throughout the coating 4 (FIG. 4), but the concentration of carbide precipitates 10 is greatest at the surface 8 and diminishes with depth into the coating 4. The coating 4 thus has a carbide precipitate gradient. The carbide precipitates 10, while generally of the same chemical compound for any coating 4, may be carbide compounds of a variety of metals including tungsten, titanium, chromium and tantalum.

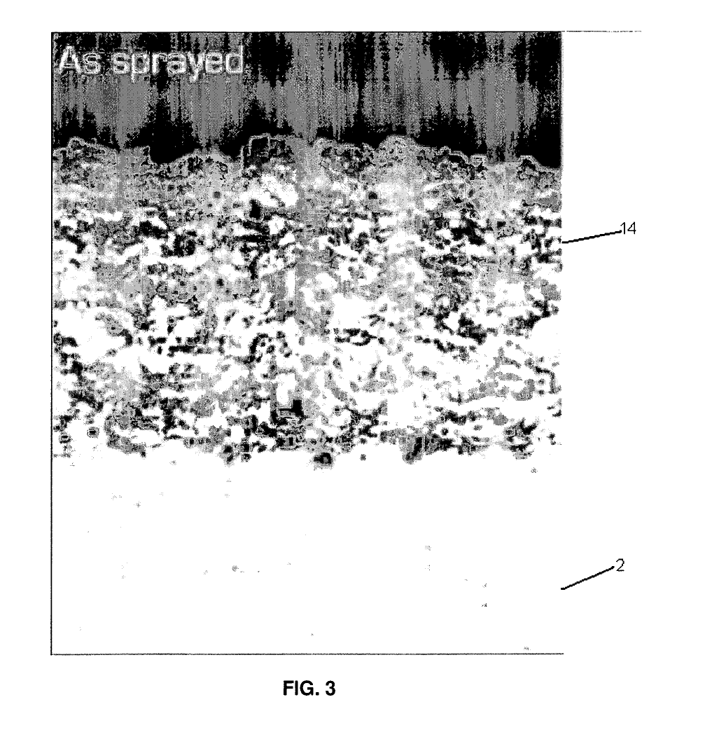

The process for applying the coating 4 to the substrate 2 is a two-step process. First, a basic metallic coating 14 (FIG. 3) is applied to a surface of the substrate 2 by thermal spraying or some other thermal process, such as welding, although thermal spraying is preferred. Then the basic coating 14 is subjected to carburizing to convert it into the protective coating 4.

In the thermal spraying step a wire feed stock is fed into an arc through which a high velocity stream of air flows. That air is directed toward the surface of the substrate 2 that is to be coated. Most of the constituents in the wire melt in the arc, and the air propels the molten constituents (and any constituents that may remain solid) against the substrate where the constituents solidify into a basic coating 14 that is attached to the substrate 2 with a mechanical bond. To this end, the surface should undergo a cleaning prior to the thermal spraying to remove oxides and other contaminants that might detract from the bond. The basic coating has 5% to 15% porosity.

The wire fed into the arc is tubular in form, having a metal case and a core containing a composite of metal or metal carbides. For example, the case may be nickel, while the core may be 60% tungsten carbide and 10% cobalt carbide in composite form. Preferably carbide granules are packed tightly together in the core and partially sintered, all without having undergone oxidation. When the wire is subjected to the arc, the metal of the case melts. The carbon in the carbide composite of the core disassociates from the metals of the carbides, leaving pure metals in a molten form to be propelled with the molten metal of the case toward and against the surface of the substrate 2 to produce the basic metallic coating 14. At elevated temperatures, the coating will diffuse into the substrate forming a metallurgical interface. Thus, the basic coating is to a measure an alloy bonded to the substrate 2. The metals for the most part do not oxidize in the air. Instead, the oxygen in the air combines with the carbon liberated from the carbides to produce carbon dioxide that shields the molten metals as they are propelled to the substrate.

AMC 3101 wire, which is available from ArcMelt Company of St. Louis, Mo., represents one wire—indeed, the preferred wire—for use as the feed stock in the thermal spraying step. That wire forms the subject of international provisional patent application PCT/US2007/088373, filed 20 Dec. 2007, which is incorporated herein by reference. As set forth in the noted PCT application, the wire, which has a tubular case that encapsulates a core, is produced from a tube of a ductile metal, preferably nickel, with the tube initially being filled with powder, the chemical constituency of which is that of the core—in this instance carbides of the metal desired for the ultimate coating 4. The filling occurs in an inert atmosphere, such as argon, and once the tube is filled its ends are closed, for example, by swaging, rendering them air tight so that the powder is contained in an oxygen free environment. Other means can be used to close the ends of the tube. Then the tube is reduced in diameter and extended in length by roll forming or perhaps drawing. This tightly compacts the powder within the tube, but it also work hardens the tube. Next the tube is heated, preferably in an oxygen-free atmosphere, to a temperature hot enough for annealing and hot enough to effect a partial sinter of the powder within the tube. The tube is allowed to cool slowly and it thus undergoes an anneal which leaves it ductile again. The ductile tube of reduced diameter thereupon undergoes a further reduction in diameter, such as by drawing or even roll forming, and this further fractures the sintered contents of the tube, leaving the contents in the form of particles. A further elevation in temperature, preferably in an oxygen-free environment, effects another sinter and results in annealing as the tube is thereafter allowed to slowly cool. The cycle of reducing in diameter and fracturing the sintered contents and then heating to partially resinter and anneal is replicated until the tube is reduced to a diameter required for the wire that is used for flame spraying. After the final cycle, the tube exists in a ductile condition, whereas the core exists as a partial, yet fractured, sinter.

The carburizing step occurs in a high temperature atmosphere devoid of oxygen. Preferably, the substrate 2 with the basic coating 14 bonded to it is placed in a furnace. Here it is heated to elevate its temperature to between about 1200° F. and about 1800° F. (between about 648° C. and about 982° C.) and preferably to between about 1750° F. and about 1800° F. (between about 854° C. and about 982° C.). In the alternative, the substrate 2 with the basic coating bonded 14 to it may be induction heated in an oxygen-free atmosphere. Moreover, a gas, such as methane, that is rich in carbon is introduced into the furnace or atmosphere. It infiltrates the basic coating 14 through the pores at the exposed surface of the basic coating 14 and diffuses into the basic coating. Other procedures for introducing carbon may be used as well. The carbon in the gas combines with the most reactive of the metals in the basic coating to form a carbide of that metal. Typically, the metal is tungsten and the carbide is tungsten carbide. As such, the coating 4 can contain 30% to 40% tungsten metal and be low in oxide content. Some of the carbon from the gas may combine with less reactive metals in the basic coating, forming carbides of those metals as well, but in lesser quantities and smaller size. For example, chromium carbide precipitates may form if chromium forms a constituent of the wire feed stock. The remaining metal or metals in the basic coating 14, typically mostly nickel, encapsulate the carbide precipitates 10 and form the matrix 12 of the protective coating 4, although a small amount of the remaining metal diffuses into the substrate to form a metallurgical bond or interface with the substrate.

In contrast to a more traditional coating in which the carbides derive from the starting compositions for those coatings and retain their original size and nodular shape, the carbide precipitates 10 in the protective coating 4 are produced in situ. To be sure, the wire feed stock used in thermal spraying step may contain similar carbide composites, but the carbides loose their carbon and identity in the thermal spraying, and basically only metals deposit on the substrate 2. Hence, the basic coating 14 is essentially all metal and does not include carbides. Only after the carbon-rich gas infiltrates the sprayed basic coating 14 and the basic coating 14 is carburized do the carbide precipitates 10 develop within the basic coating 14 to produce the coating 4. Indeed, each carbide precipitate 10 may derive from a multitude of carbide precipitates that grow and unite together, providing the enlarged size for the precipitates 10 and their irregular configuration, including the angular projections and recesses (FIG. 5).

Should the matrix 12 between the enlarged precipitates 10 at the exposed surface 8 disintegrate, the large carbide precipitates 10 will remain intact and in place, captured at their angular projections and recesses by the matrix 12, and thus resist further disintegration of the matrix 12. Indeed, the enlarged carbide precipitates 10 provide a carbide surface that in area exceeds those formed by nodular particles in more traditional coatings.

Since the coating 4 is deposited on the substrate 2 by thermal spraying, it may be applied to substrates 2 with surfaces having severe curvatures and sharp angles—surfaces that could not be accommodated with coatings derived from sheet material.

The substrate 2 with only the basic metallic coating 14 applied to it, that is the coating as initially sprayed (FIG. 3), may acquire the protective coating 4 in use. For example, if the substrate 2 itself is used in a high temperature carbon-rich atmosphere, such as in a coal gasification process, the basic metallic coating 14 will absorb carbon from that atmosphere and develop carbides, thus transforming into the protective coating 4 that will protect the substrate 2 from corrosion.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A structure comprising:
a substrate comprising metal, and
a basic coating mechanically bonded to the substrate, the basic coating comprising a first metal and a second metal, and having essentially no carbides and a porosity of about 5% to about 15%;
wherein the first metal will form a carbide in preference to the second metal if the basic coating is exposed to a reducing environment containing carbon at an elevated temperature.

17. The structure according to claim 16, wherein the elevated temperature is within the range of about 1200° F. to about 1800° F.

18. The structure according to claim 16, wherein the first metal comprises a material selected from the group consisting of:
tungsten;
titanium;
chromium; and
tantalum.

19. The structure according to claim 16, wherein the second metal comprises nickel.

20. The structure according to claim 16, wherein the second metal comprises cobalt.

21. The structure according to claim 16, wherein after an exposure to said reducing environment containing carbon at an elevated temperature the basic coating forms a protective coating comprising a metal matrix, the matrix comprising carbide precipitates formed predominantly of the first metal, the carbide precipitates being embedded in and interlocking with the matrix and having an irregular shape.

22. The structure according to claim 21, wherein the carbide precipitates comprise a dendridic structure.

23. The structure according to claim 21, wherein the exposure of the basic coating to said reducing environment containing carbon at an elevated temperature occurs during use of the structure of which the substrate is a part.

24. A process for providing a metal substrate with a protective coating, said process comprising:
depositing a plurality of metals on the substrate through the application of heat to form a basic coating that is essentially metals bonded to the substrate, the basic coating comprising a first metal and a second metal, and having a porosity of about 5% to about 15%, wherein the first metal will form a carbide in preference to the second metal if the basic coating is exposed to a reducing environment containing carbon at an elevated temperature;
heating the basic coating bonded to the substrate to the elevated temperature; and
exposing the basic coating bonded to the substrate to a reducing environment having carbon while at the elevated temperature, so that the carbon combines predominantly with the first metal in the basic coating to form the protective coating having precipitated carbides embedded in a metal matrix within said protective coating.

25. The process according to claim 24, wherein the basic coating is deposited by thermal spraying.

26. The process according to claim 25, wherein the basic coating is derived from a wire comprising a metal case and a core containing metal carbides.

27. The process according to claim 26, wherein depositing a plurality of metals comprises heating the wire hot enough to melt the case and to disassociate the carbon from the metal of the carbides of the core.

28. The process according to claim 27, wherein the carbon liberated from the metals of the carbide combines with oxygen to form carbon dioxide.

29. The process according to claim 28, wherein the formation of carbon dioxide reduces the level of oxidation of one or more of said plurality of metals during the step of depositing a plurality of metals on the substrate through the application of heat to form a basic coating.

30. The process according to claim 24, wherein one or both of the steps of heating the basic coating bonded to the substrate to the elevated temperature, and exposing the basic coating bonded to the substrate to a reducing environment having carbon while at the elevated temperature, occurs during use of the substrate following the step of depositing a plurality of metals on the substrate through the application of heat to form a basic coating.

31. The process according to claim 30, wherein said use comprises one or more steps of a coal gasification process.

32. The process according to claim 24, wherein the elevated temperature is within the range of about 1200° F. to about 1800° F.

33. The process according to claim 24, wherein the protective coating is metalurgically bonded to the substrate.
